(19) United States
(12) Patent Application Publication
(10) Pub. No.: US 2025/0095009 A1
(43) Pub. Date: Mar. 20, 2025

(54) PRODUCT DESCRIPTION SUPPORT SYSTEM

(71) Applicant: KABUSHIKI KAISYA LEBEN, Yokohama-shi (JP)

(72) Inventor: Atsushi TAKABU, Kanagawa (JP)

(21) Appl. No.: 18/963,714

(22) Filed: Nov. 28, 2024

Related U.S. Application Data
(63) Continuation of application No. PCT/JP2024/004829, filed on Feb. 13, 2024.

(30) Foreign Application Priority Data
Feb. 13, 2023 (JP) 2023-020258
Dec. 22, 2023 (JP) 2023-217041
Jan. 23, 2024 (JP) 2024-008268

(51) Int. Cl. G06Q 30/0202; G06Q 30/0251

(52) U.S. Cl. CPC G06Q 30/0202; G06Q 30/0257; G06Q 30/0269

(57) ABSTRACT

The present invention provides a product description support system executed by a computer system including a management server. This system includes an access reception unit that receives access using an identifier (e.g., URL) associated with a product; a content change unit that modifies content data associated with the identifier based on predetermined provision conditions; a content transmission unit that delivers the modified content to the user's terminal for display; and an access history management unit that records the provision history of the content. The content change unit selects content data by adopting one of various methods, such as evaluating access counts, user levels, elapsed time, viewing duration, or regional information, to tailor content to specific user conditions. The system enables dynamic content adaptation for enhanced user engagement, utilizing criteria like product sales regions, customer attributes, and past behavior to optimize the delivery of relevant product information.

### BACKGROUND

### Technical Field

The present invention relates to a product description support system. The present invention claims priority based on the Japanese patent applications numbered 2023-020258 filed on Feb. 13, 2023, 2023-217041 filed on Dec. 22, 2023, and 2024-008268 filed on Jan. 23, 2024. For countries where incorporation by reference is allowed, the content described in these applications is incorporated herein by reference.

### Related Art

JP 2016-004463 A discloses a proxy management server that accepts the management of a product provider's two-dimensional code and content through a terminal belonging to the product provider. This server includes a two-dimensional code designation receiving unit to accept specifications of two-dimensional codes, a management information reception unit for receiving management information to confirm the designated content, a content reception unit to accept one or more pieces of content associated with the designated code, a storage unit to store the correspondence among the two-dimensional code, management information, and content, a management information transmission unit to send the information for confirming the correspondence among the two-dimensional code, the management information, and the content to the product provider's terminal, and a distribution unit to distribute content associated with the two-dimensional code to the end user's terminal when it is scanned.

### SUMMARY

In the technology described above, a server can be provided to manage and associate barcodes with content according to the product provider's instructions. However, even if a potential customer picks up a product displayed in-store and becomes interested, they may not feel compelled to purchase based solely on package explanations, point-of-purchase materials, or the content uniformly provided as described above. Additionally, when they do purchase the product, they may not fully understand how to use it, leading to a lack of satisfaction with the product.

The objective of the present invention is to provide useful information easily for both products before purchase and after purchase.

The present application discloses a plurality of means for solving at least some of the above problems, but examples of such means are as follows. A product description support system executed by a computer system that includes a management server, comprising:
An access reception unit that accepts access performed using an access identifier (e.g., URL) included in a code pre-associated with a product when read by the customer's user terminal;
A content change unit that selects content data corresponding to the access identifier from among multiple pieces of pre-stored content data according to predetermined provision conditions, thus changing the content data associated with the access identifier;
A content transmission unit that sends the changed content data to the customer's terminal for display, allowing it to be viewed on the user terminal;
And an access history management unit that records the provision history of each content data.

The content change unit adopts one of the following methods to select the content data:
Method 1) Selecting content data that meets a predetermined provision count from among the multiple pieces of content data;
Method 2) Obtaining the access count N, representing the number of accesses to the access identifier used by the customer's user terminal, and selecting content data that meets the provision count from among the multiple pieces of content data;
Method 3) Selecting content data that provides more detailed information based on the access count N;
Method 4) Managing the customer's user level, where the user level increases with more frequent accesses, and if content data with a lower level than the current user level is requested, the user level is lowered to the level of the requested content data. Content data is then selected according to the user level;
Method 5) Obtaining the most recent access date and time for the access identifier used on the customer's user terminal and selecting content data based on the elapsed time since the access date and time;
Method 6) Determining the average viewing time or percentage of viewing time for videos related to past accesses at the customer's user terminal, and selecting video content data with playback time corresponding to the average viewing time or percentage of viewing time;
Method 7) Selecting content data in descending order of purchase rates for the product associated with the content data within a specified time after viewing;
Method 8) The memory unit in the management server contains information associated with the sales region for each product and information corresponding to the region and time period for each content data. The content change unit specifies the current time, identifies the product associated with the URL used for access, and selects, from among the multiple pieces of content data, content data for which the sales region of the identified product corresponds to the provision region, and the current time corresponds to the time period, prioritizing content with higher purchase rates within a specified time after viewing;
Method 9) Selecting different content data based on whether or not the product associated with the URL used for access has been purchased;
Method 10) Obtaining at least one of gender, age group, and occupation from the attribute information of the customer who accessed said customer's user terminal, and selecting content data from among the multiple pieces of content data using the information in the memory section, wherein the attribute information of the customer satisfies the target person attributes to be provided.

According to the present invention, technology can be provided to easily deliver useful information on products both before and after purchase.

Challenges, configurations, and effects other than those mentioned above will be clarified through the following description of embodiments.

### BRIEF DESCRIPTION OF DRAWINGS

FIG. 1 is a diagram illustrating a configuration example of a product description support system according to the embodiment;

FIG. 2 is a diagram illustrating a configuration example of a QR code (registered trademark);

FIG. 3 is a diagram illustrating a configuration example of a management server;

FIG. 4 is a diagram illustrating a configuration example of the data structure for product information, QR code information, and access history information;

FIG. 5 is a diagram illustrating a configuration example of the data structure for content information, content provision condition information, and content association information;

FIG. 6 is a diagram illustrating a configuration example of the hardware configuration of the management server;

FIG. 7 is a diagram illustrating a configuration example of a flowchart of QR code issuance process;

FIG. 8 is a diagram illustrating a configuration example of screen transitions during QR code issuance;

FIG. 9 is a diagram illustrating a configuration example of a flowchart of a content provision process;

FIG. 10 is a diagram illustrating a configuration example of content selection based on time periods;

FIG. 11 is a diagram illustrating a configuration example of content selection based on regions;

FIG. 12 is a diagram illustrating a configuration example of content selection based on the number of accesses to the same URL;

FIG. 13 is a diagram illustrating a configuration example of cookie information in the second embodiment (use of cookies);

FIG. 14 is a diagram illustrating a configuration example of a flowchart of content provision process in the second embodiment;

FIG. 15 is a diagram illustrating a configuration example of user account information in the third embodiment (use of an application);

FIG. 16 is a diagram illustrating a configuration example of a flowchart of content provision process in the third embodiment;

FIG. 17 is a diagram illustrating a configuration example of a flowchart of product purchase history collection in the fourth embodiment;

### DETAILED DESCRIPTION

Hereinafter, a product description support system 1 according to one embodiment of the present invention will be described with reference to the drawings. For convenience in the following description, if necessary, the description will be divided into multiple sections or embodiments. However, unless explicitly stated otherwise, these sections are not independent of each other; rather, one may be a variation, detail, or supplementary explanation of another.

Furthermore, the quantities of elements (including numbers, values, amounts, ranges, etc.) mentioned in the following embodiments are not limited to specific values unless explicitly specified or inherently limited in principle. It may be greater or less than the specified number.

Moreover, the components (including elements and steps) described in the following embodiments are not necessarily essential, unless explicitly specified as such or deemed essential in principle.

In a case where there are a plurality of components having the same or similar functions, these may be described with the same reference numerals but different subscripts. In addition, in a case where there is no need to distinguish the plurality of components, subscripts may be omitted in the description.

Similarly, when referring to shapes, positional relationships, etc., of components in the following embodiments, unless explicitly specified otherwise or inherently non-applicable, they include those approximating or similar to the specified shapes or relationships. This is also applicable to the numerical values and ranges mentioned above.

In addition, identical reference numerals are given to identical parts across all figures describing the embodiments, and repeated explanations are omitted.

### First Embodiment

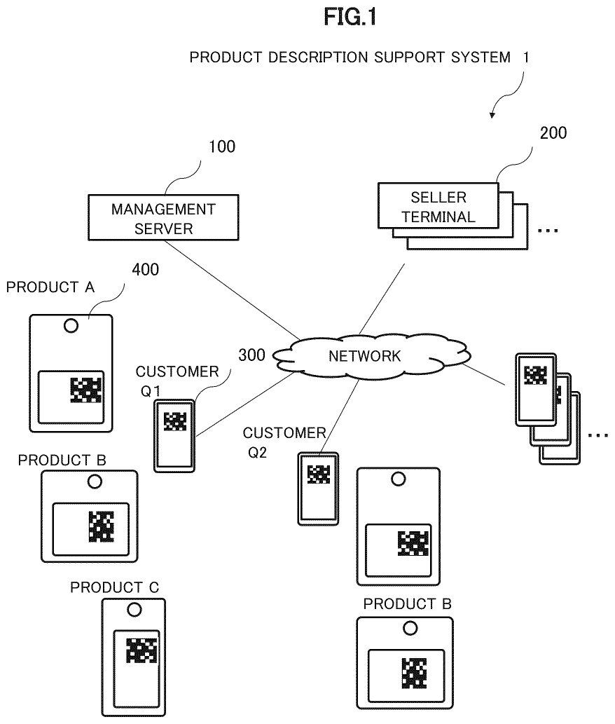

FIG. 1 is a diagram illustrating a configuration example of a product description support system according to the present embodiment.

The product description support system 1 includes a management server 100, a seller terminal 200, and a user terminal 300. The store staff uses the seller terminal 200, while the customer uses a user terminal 300, such as their smartphone. Both the seller terminal 200 and the user terminal 300 can read QR codes or images printed or affixed to product packages, pamphlets, flyers, promotional images, etc., to access the domain (such as web content) of the management server 100. In this embodiment and the following embodiments, an example using QR codes is described. However, this is not limited to QR codes, and any code readable by a terminal equipped with a reading device may be used, including one-dimensional barcodes, stacked codes, matrix codes, etc. Additionally, electronic tags readable via short-range wireless communication, such as NFC (Near Field Communication) or RFID (Radio Frequency Identification), may also be used.

The seller terminal 200 and user terminal 300 are information processing devices, such as smartphones, personal computers, and tablet devices, but may also include wearable terminals like smartwatches, headsets, gloves, chokers, and so forth.

The seller terminal 200 and user terminal 300 communicate with the management server 100 over data communication networks such as carrier networks or the internet, using a predetermined data transmission protocol (e.g., HTTP (Hyper Text Transfer Protocol), HTTPS (HTTP Secure)). Both the seller terminal 200 and user terminal 300 engage in web browsing using URLs (Uniform Resource Locators) to send and receive web content. For example, the seller terminal 200 and user terminal 300 can request and display corporate homepages or web content obtained from the management server 100 on a display device (not shown).

The management server 100 responds to various requests made by the seller terminal 200 and user terminal 300 through the data transmission protocol. For example, the management server 100 plays content data, such as videos, on the seller terminal 200 and user terminal 300 that have accessed the server by reading the QR code affixed to the product A400.

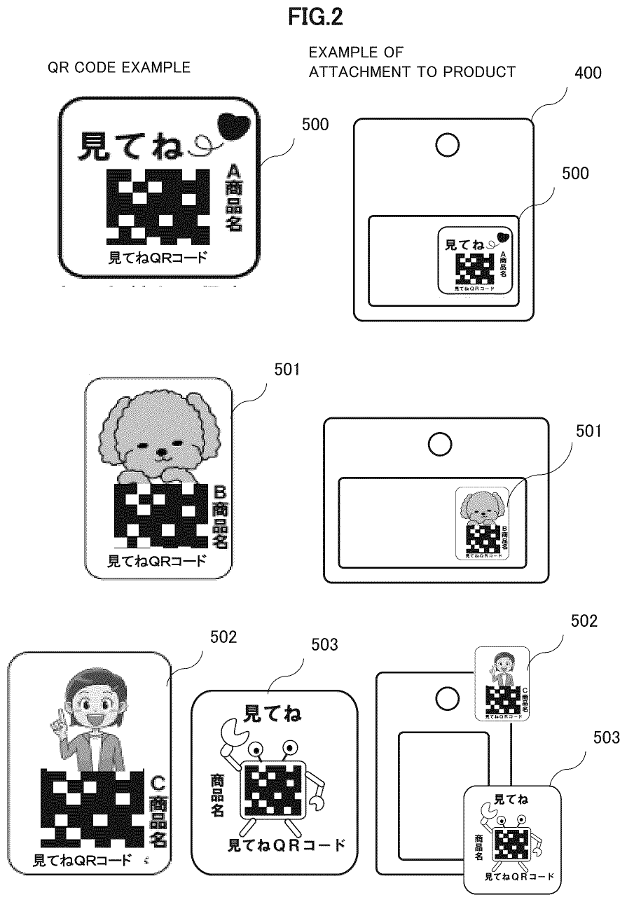

FIG. 2 is a diagram illustrating a configuration example of a QR code (registered trademark). The QR code 500 is a “Mite-ne QR Code,” a design QR code (decorated around the QR code). “Mite-ne” is Japanese and means “Look at” in English. The QR code 500 is a sticker that can be retrofitted onto items like the blister pack (packaging) of product A400. The “Mite-ne QR Code” sticker aims to capture the attention of customers who pick up product A400.

Additionally, the QR code 500 may be a “Mite-ne QR Code” with a different design. For example, QR code 501 adopts a character of an animal that has been deformed as part of the “Mite-ne QR Code.” Alternatively, QR code 502 adopts a character of a person that has been deformed as part of the “Mite-ne QR Code.” Although it is referred to here as “Mite-ne QR Code,” it could also be displayed with a catchy message like “Fun Code” or “Full of Happiness” to attract attention along with a suitable label.

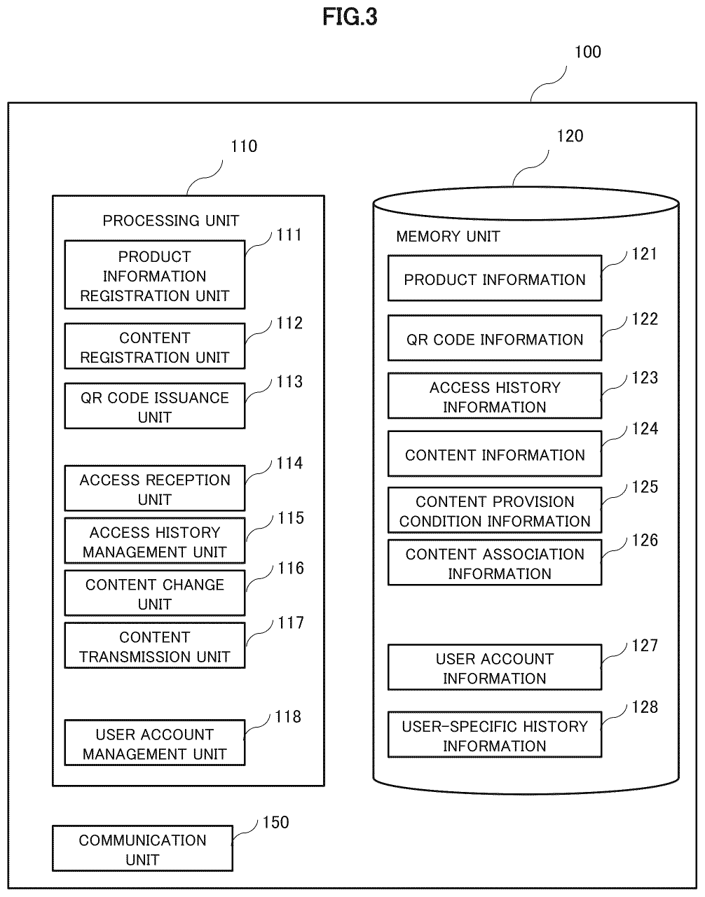

FIG. 3 is a diagram illustrating a configuration example of a management server. The management server 100 includes a processing unit 110, a memory unit 120, and a communication unit 150. The memory unit 120 stores product information 121, QR code information 122, access history information 123, content information 124, content provision condition information 125, content association information 126, user account information 127, and user-specific history information 128. The processing unit 110 includes a product information registration unit 111, a content registration unit 112, a QR code issuance unit 113, an access reception unit 114, an access history management unit 115, a content change unit 116, a content transmission unit 117, and a user account management unit 118.

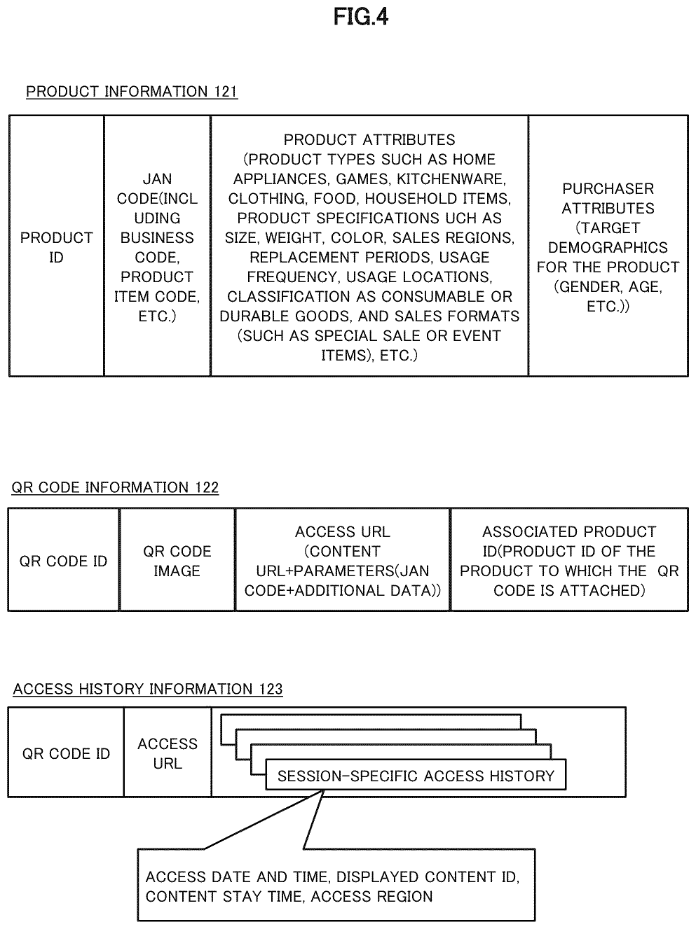

FIG. 4 is a diagram illustrating a configuration example of a data structure for product information, QR code information, and access history information. The product information 121 includes a product ID, JAN code (including business code, product item code, etc.), product attributes, and purchaser attributes. The product attributes include product types such as home appliances, games, kitchenware, clothing, food, household items, product specifications such as size, weight, color, sales regions, replacement periods, usage frequency, usage locations, classification as consumable or durable goods, and sales formats (such as special sale or event items). The purchaser attributes include the target demographics for the product (gender, age, etc.). Thus, product information 121 can be considered as information associated with sales regions for each product. It can also be considered as information linked to purchaser attributes, including at least one of gender, age range, and occupation for each product.

The QR code information 122 includes a QR code ID, QR code image, access URL, and associated product ID. The access URL contains a content URL (relative directory from the domain+root path) and parameters. Parameters include, for example, the JAN code of the product and other additional data.

Here, as the configuration of the access URL in this embodiment, URLs that facilitate easier access analysis and match various search engines are preferred. Specifically, it is desirable to use a URL such as: “https://xxx.co.jp/laben-ECS/g-code/C6-00313/jan=4988760012036/col=green/no=001/peeler.html” where “xxx.co.jp/laben-ECS” is the hostname+domain name portion, “g-code” serves as a delimiter indicating the product code, “C6-00313/jan=4988760012036” represents the product classification code and JAN code, “col=green” indicates the color classification, and “no=001” indicates a unique code for special sales, events, sales regions, etc. Additional codes, such as “siz=xl” to indicate size, can also be added. Furthermore, by using design classification codes set by the design examination standards, such as design classification codes under design law, uniformity can be achieved.

The associated product ID includes the product ID of the product to which the QR code is attached. Thus, QR code information 122 can be regarded as information that stores the URL and multiple content data for each product.

The access history information 123 includes the QR code ID, access URL, and session-specific access history. The session-specific access history contains information such as access date and time, displayed content ID, content stay time (display time), and for videos, the ratio of display time to the total video duration, as well as the access region. The access region is estimated from the IP address or other data of the area where the seller terminal 200 or user terminal 300 accessed by reading the QR code. The accessed region may include areas such as prefectures, not only base station-level areas.

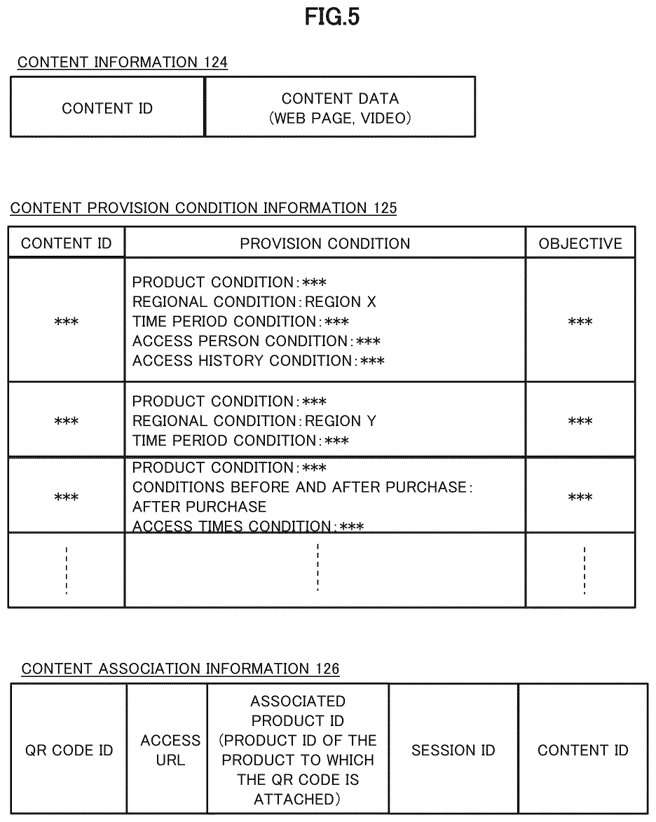

FIG. 5 is a diagram illustrating a configuration example of a data structure for content information, content provision condition information, and content association information. The content information 124 includes associations between content IDs and content data. Content data refers to either the actual content data (such as web pages, images, videos, etc.) or a path (URI of a website, etc.) where the content data can be obtained.

The content provision condition information 125 includes content IDs, provision conditions, and objectives. The provision conditions include various combinations of provision conditions and the content ID provided in response to each combination. Combinations of various provision conditions can take various forms; for example, even if the product ID is the same, when there are products for region X (local model) and region Y, it is necessary to provide content tailored to each region, and thus the information includes the provision region associated with each piece of content data.

Additionally, the information that customers seek may differ before and after purchasing a product. In this case, it is assumed that pre-purchase access occurs from an in-store location, while post-purchase access occurs from a location outside the store, such as the customer's home. Thus, content data can be associated with the access region as a provision condition.

Furthermore, it is assumed that customers may desire different information based on the number of times they access a product, such as the first access or subsequent access, or based on the elapsed time since the initial access. In such cases, it is possible to associate content data with each condition by using the access count or the elapsed time since the first access as provision conditions. In addition to these examples, various information such as JAN code, product attributes, purchaser attributes, and the time of access can be used as provision conditions to associate content data accordingly.

For example, the provision conditions may include associating the content data with specific time periods during which it is available, or associating the sales region of the product with the region in which the content data is available. Alternatively, purchaser attributes, including at least one of gender, age group, and occupation, may be associated as provision conditions.

Additionally, it is possible to associate content data that satisfies a predetermined provision count recorded in the access history information 123 for each piece of content data.

Preferably, as the number of provisions to a specific customer increases, the content data associated with more detailed product descriptions can be provided. Alternatively, it is desirable to identify the average viewing time (the average of past display times) for videos related to past accesses on the customer's user terminal and use content data for videos with playback times corresponding to the average viewing time as provision conditions. Alternatively, it is also acceptable to identify the viewing time ratio (the ratio of display time to the total time of past videos) for videos related to past accesses on the customer's user terminal and use content data for videos with playback times corresponding to the viewing time ratio as provision conditions.

The “Objective” stores a description explaining the purpose of setting the provision conditions for the content. By referencing the “Objective,” the provider can confirm the intent of providing the content to customers who meet the provision conditions.

The content association information 126 includes the QR code ID, access URL, associated product ID, session ID, and content ID. The session ID is information that identifies each HTTP session of the seller terminal 200 and user terminal 300 connected simultaneously to the management server 100. By sharing the session ID in a stateless HTTP protocol, the management server 100 can secure a continuous process flow. The management server 100 then controls the content provided to each seller terminal 200 and user terminal 300 by rewriting the content ID associated with the session ID as appropriate. Note that the content ID associated with each QR code ID is not limited to a single content; multiple content IDs can be associated in sequence so that video content can be played in succession.

The product information registration unit 111 accepts input for information to be stored in product information 121 and registers this information in product information 121. The content registration unit 112 accepts content data (web pages or videos) and registers it in content information 124 and content provision condition information 125. The QR code issuance unit 113 issues a QR code that includes the access URL and product ID.

The access reception unit 114 accepts access performed using the URL included in the QR code. Specifically, the access reception unit 114 accepts access (HTTP or HTTPS requests) from a user terminal 300 or seller terminal 200 when they pick up product A400 in a store and access the URL included in the QR code attached to the product in advance.

The access history management unit 115 records the provision history for each content data. Specifically, the access history management unit 115 stores the access history in access history information 123.

The content change unit 116 manages changes in the content data associated with the URL included in the QR code on a session-by-session basis by selecting from multiple pre-stored content data based on predetermined provision conditions. Specifically, the content change unit 116 identifies the product associated with the URL accessed, then selects content data that meets the predetermined provision conditions from among the content data associated with the identified product, thereby updating the content data associated with the URL. If there are multiple pieces of content that meet the provision conditions, one piece of content is selected based on a pre-established priority order and associated with the URL. The priority order could be based on the number of conditions met, the newest creation date of the content, or the shortest playback time of the content data.

Specifically, for example, the content change unit 116 identifies the current time and selects content data that corresponds to the time range of provision conditions from among multiple content data using the content provision condition information 125.

Additionally, the content change unit 116 uses the information from the QR code information 122 to identify the product associated with the URL used for access, determines the sales region of the identified product using the product information 121, and selects, from among the multiple pieces of content data, the content data for which the identified sales region corresponds to the provision region. Alternatively, the content change unit 116 identifies the access region of the user terminal 300 using the IP address included in the network connection information from the user terminal 300 and selects, from among the multiple pieces of content data, the content data for which the access region corresponds to the provision region.

Furthermore, the content change unit 116 identifies the purchaser target attributes associated with the specified product using the information in the QR code information 122, and selects content data that matches the target attributes from among multiple pieces of content data.

The content change unit 116 can also be set to select content data that has met a predetermined provision count from among multiple pieces of content data. In other words, the content change unit 116 may be configured to select content that has been played frequently.

Additionally, if the QR code information 122 includes purchase history information (such as product ID, store of purchase, purchase date, and quantity) indicating that the product has been purchased, the content change unit 116 can select different content data based on whether the product has been purchased or not. For instance, if the product has not been purchased, the content data promoting the product for sale is selected under the provision condition of “pre-purchase.” Conversely, if the product has already been purchased, content data explaining the detailed usage of the product is selected under the provision condition of “post-purchase.”

Furthermore, the content change unit 116 may also be configured to select content that satisfies all provision conditions, such as time, sales region, purchaser attributes, and provision count, as described above. Alternatively, the content change unit 116 may be configured to select content that satisfies one or more of the provision conditions. If there are multiple pieces of content that meet the conditions, one piece of content is selected according to a predefined priority order, as mentioned above, and is associated with the URL.

Additionally, to display the content currently most desired for promotion, the content change unit 116 may select content data for related products within the same category as the product with the QR code, for a specified time period.

The content transmission unit 117 sends the content data, which has been modified by the content change unit 116, to the user terminal 300 and allows it to be displayed for viewing on the user terminal 300.

The user account management unit 118 assigns a unique user ID that distinguishes the user (customer) from other users and generates user account information 127 and user-specific history information 128.

The communication unit 150 enables communication with the seller terminal 200 and user terminal 300 over data communication networks, including the internet.

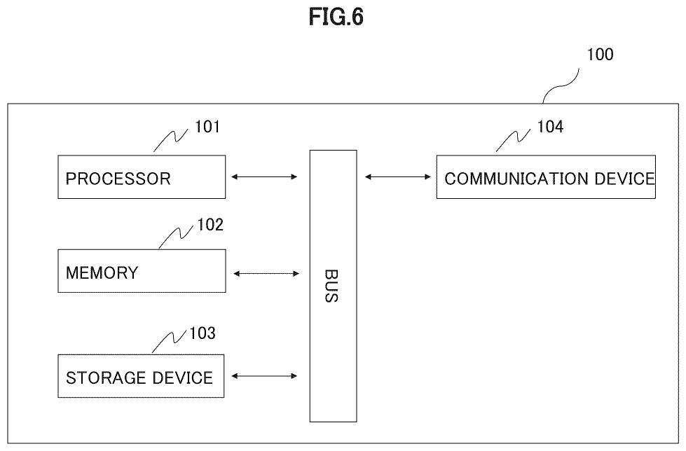

FIG. 6 is a diagram illustrating a configuration example of a hardware configuration of the management server. The management server 100 is equipped with a hardware configuration implemented using a so-called server device, workstation, personal computer, smartphone, or tablet terminal casing. The management server 100 includes hardware components such as a processor 101, memory 102, storage device 103, communication device 104, and a bus that connects these components.

The processor 101 is a computation device, such as a CPU (Central Processing Unit) or GPU (Graphics Processing Unit).

The memory 102 is a memory device, such as RAM (Random Access Memory).

The storage device 103 is a non-volatile storage device capable of storing digital information, such as a hard disk drive (HDD), solid-state drive (SSD), or flash memory.

The communication device 104 is a network interface card (NIC) or similar device that enables communication with other devices through data communication networks.

The product information registration unit 111, content registration unit 112, QR code issuance unit 113, access reception unit 114, access history management unit 115, content change unit 116, content transmission unit 117, and user account management unit 118 in the management server 100 are implemented by a program executed by the processor 101. This program is stored in memory 102, storage device 103, or a ROM device (not shown) and loaded into memory 102 for execution by the processor 101.

The memory unit 120 of the management server 100 is implemented by the memory 102 and storage device 103. The communication unit 150 is implemented by the communication device 104. This is an example of the hardware configuration of the management server 100.

The configuration of the management server 100 can be further divided into more components based on processing requirements. Alternatively, a single component can perform additional functions if necessary.

Additionally, each processing unit (such as the product information registration unit 111, content registration unit 112, QR code issuance unit 113, access reception unit 114, access history management unit 115, content change unit 116, content transmission unit 117, and user account management unit 118) can be constructed using dedicated hardware (such as ASIC or GPU) to achieve each function. Furthermore, the processing of each unit can be performed on a single hardware device or across multiple hardware devices. The seller terminal 200 and user terminal 300 can also have hardware configurations that are essentially the same as the management server 100.

Next, the operation of the product description support system 1 in this embodiment will be described.

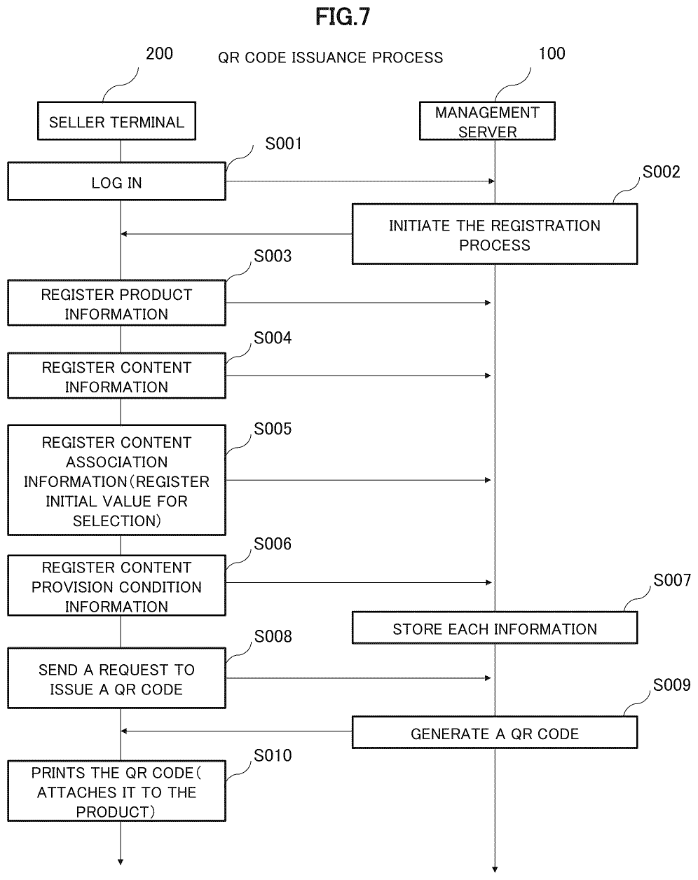

FIG. 7 shows an example of the flow of the QR code issuance process. The QR code issuance process enters a standby state when the management server 100 is operational and begins upon receiving a login request from the seller terminal 200.

First, the seller terminal 200 logs into the management server 100 (Step S001). As for the login process, it may involve any standard authentication method, such as password authentication, biometric authentication, passcode authentication, or image recognition authentication. Once login is confirmed, the product information registration unit 111 initiates the registration process (Step S002). Specifically, the product information registration unit 111 displays the seller input screen 600 on the seller terminal 200.

When product information is received from the seller terminal 200, the product information registration unit 111 registers the information in product information 121 (Step S003, Step S007). When content information is received from the seller terminal 200, the content registration unit 112 registers the content information in content information 124 (Step S004, Step S007). When content association information is received from the seller terminal 200, the content registration unit 112 registers it in content association information 126 (Step S005, Step S007). When information about the conditions for providing content is received from the seller terminal 200, the content registration unit 112 registers it in content provision condition information 125 (Step S006, Step S007).

When the seller terminal 200 sends a request to issue a QR code (Step S008), the QR code issuance unit 113 generates the QR code using the information received in Steps S003 to S006 (Step S009). Specifically, the QR code issuance unit 113 generates a QR code image by encoding a string that includes the access URL and product ID using an existing encoding algorithm, and displays it on the seller terminal 200. The timing of the QR code issuance request can be determined as needed by the user of the seller terminal 200, and it can be done multiple times.

The seller terminal 200 then prints the QR code as a sticker and attaches it to the product (Step S010).

The processing described for the seller terminal 200 can be performed not only by retailers but also by manufacturers. During production or before shipping, manufacturers can also attach a “Mite-ne QR Code” to the product (such as on the package or main body) by following a similar process. Furthermore, for customers who are already registered members, the “Mite-ne QR Code” can be sent as an image via a newsletter, for example.

This concludes the processing content of the QR code issuance process. The QR code issuance process enables easy creation and printing of “Mite-ne QR Codes” that are tailored to product information and capable of dynamically displaying various content data according to provision conditions.

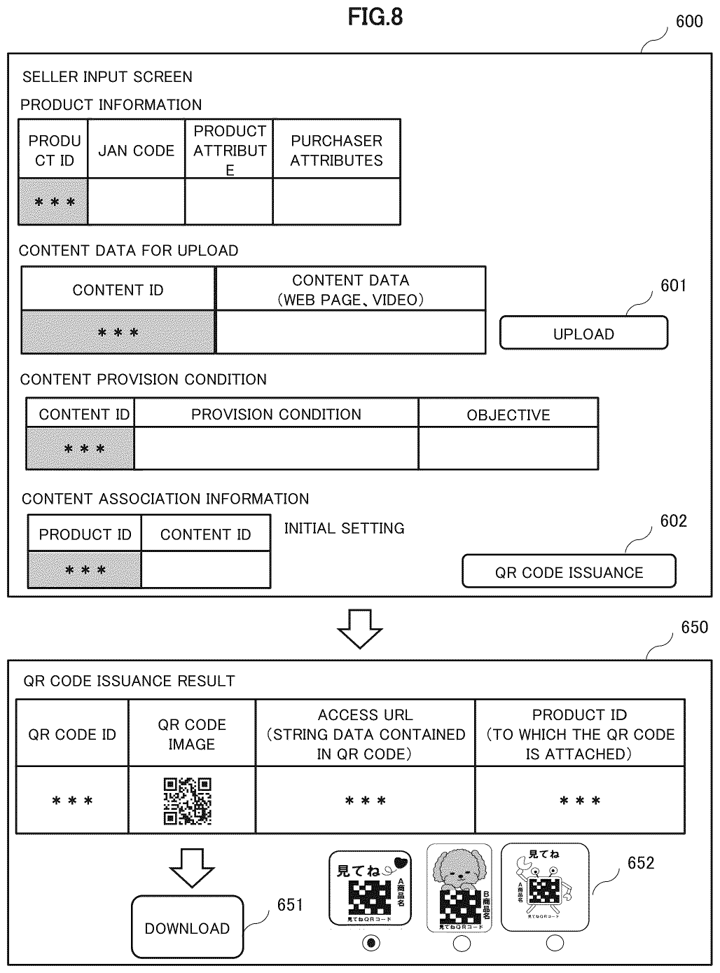

FIG. 8 shows an example of the screen transitions during QR code issuance. At Step S002 in the QR code issuance process, the seller input screen 600 sent from the management server 100 is displayed on the seller terminal 200. The seller input screen 600 includes fields to receive inputs for product information, content information, condition information for content provision, and content association information, along with an upload button 601 for uploading content information and a QR code issuance button 602. The upload button 601, when clicked, uploads the entered content information to the management server 100. The QR code issuance button 602, when clicked, sends the entered product information, condition information for content provision, and content association information to the management server 100, triggering a screen transition to the QR code issuance result screen 650.

The QR code issuance result screen 650 displays the QR code ID, QR code image, access URL, and product ID. Additionally, a download button 651 is provided on the QR code issuance result screen 650 to allow the QR code image to be downloaded for printing. When the download button 651 is clicked, the “Mite-ne QR Code” can be downloaded, and the print data is output to a printer. The QR code issuance unit 113 may also display a selection of designs 652 that include the “Mite-ne QR Code” and send the selected design's “Mite-ne QR Code” to the seller terminal 200.

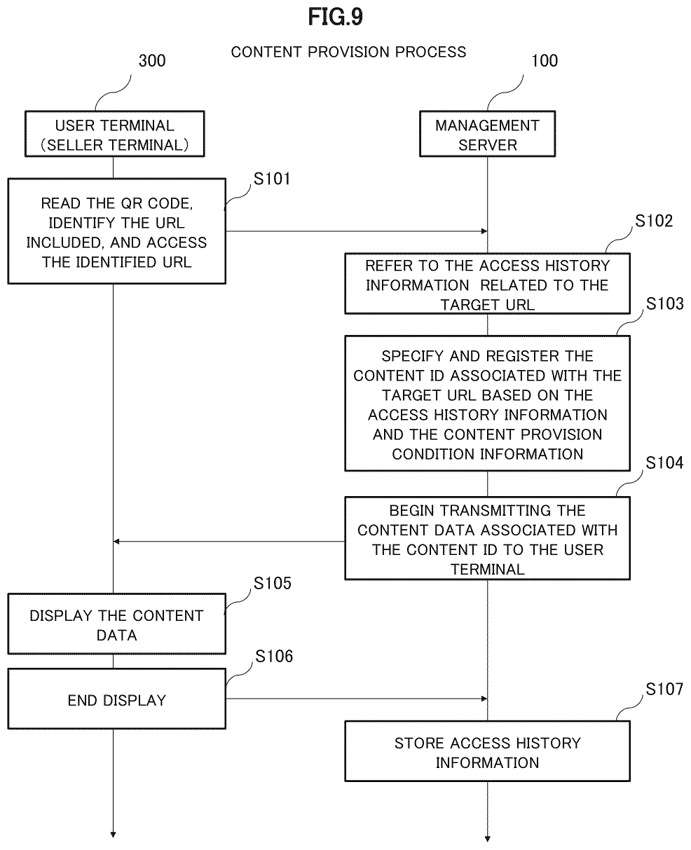

FIG. 9 is a diagram illustrating a configuration example of a flowchart of a content provision process. The content provision process enters a standby state when the management server 100 is operational and begins upon receiving access from the user terminal 300.

First, the user terminal 300 reads the QR code labeled “Mite-ne QR Code” (QR code 500), identifies the URL included, and accesses the specified URL (Step S101). When the access reception unit 114 accepts the access, it refers to the access history information 123 related to the target URL (Step S102). Then, the content change unit 116 specifies the content ID associated with the target URL based on the access history information 123 and the content provision condition information 125, and registers this in the content association information 126 for the relevant session (Step S103). The content transmission unit 117 then begins transmitting the content data associated with the registered content ID to the user terminal 300 (Step S104). The content transmission unit 117 “begins” transmitting content data because the content may involve streaming playback of videos. If the content does not require streaming, the content transmission unit 117 transmits the content data in one go.

Then, the user terminal 300 displays the content data (Step S105) until the display ends (Step S106). The access history management unit 115 stores access history information, including the content data ID that was displayed, in the access history information 123 (Step S107).

If the streaming playback of the content data ends, the content transmission unit 117 may continue to play other content data as long as viewing continues.

This concludes the content provision process. With this process, customers (users) can view content data tailored to the content provision conditions and based on the access history. This enables them to easily obtain useful information on products before or after purchase.

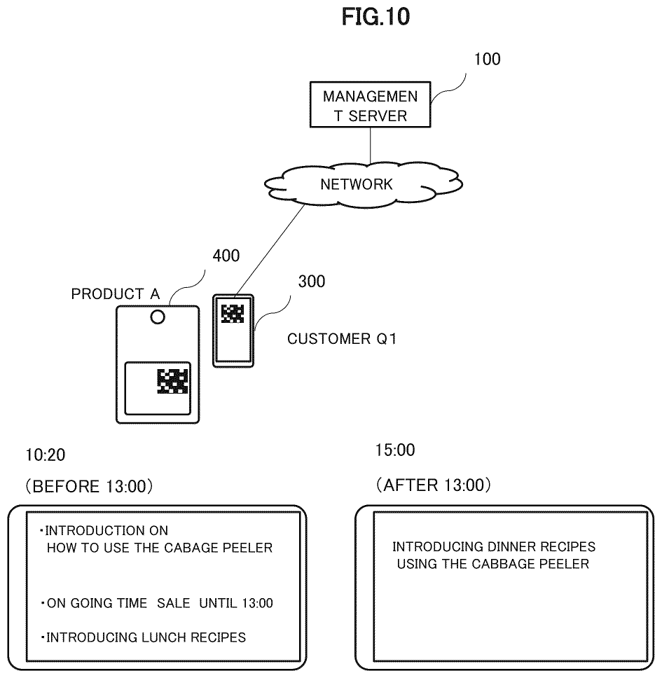

FIG. 10 is a diagram illustrating a configuration example of a content selection based on time periods. In the example shown in FIG. 10, the content data provided by the management server 100 changes between the time periods before 1:00 PM and after 1:00 PM. For example, if the “Mite-ne QR Code” is associated with the product “Cabbage Peeler” and access is made from the user terminal 300 at 10:20 AM, the content data may include a video introduction on how to use the cabbage peeler, information on an ongoing time sale, or a video introducing lunch recipes. However, if access is made from the user terminal 300 at 3:00 PM, the content data may include a video introducing dinner recipes using the cabbage peeler.

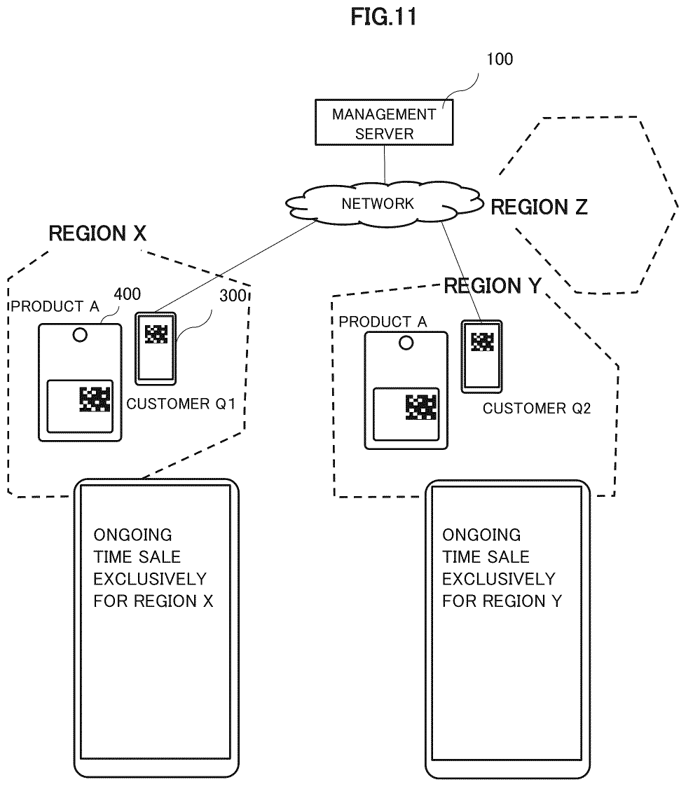

FIG. 11 is a diagram illustrating a configuration example of a content selection based on regions. In this example, the content data provided by the management server 100 varies depending on the region in which the product is sold. For example, if the “Mite-ne QR Code” is associated with the product “Cabbage Peeler” and the QR code includes the JAN code for Region X (e.g., the Hokkaido region), the content data provided upon access from the user terminal 300 may include information about an ongoing time sale exclusively for Region X. However, if the QR code includes the JAN code for Region Y (e.g., the Okinawa region), the content data provided upon access from the user terminal 300 may include information about an ongoing time sale exclusively for Region Y.

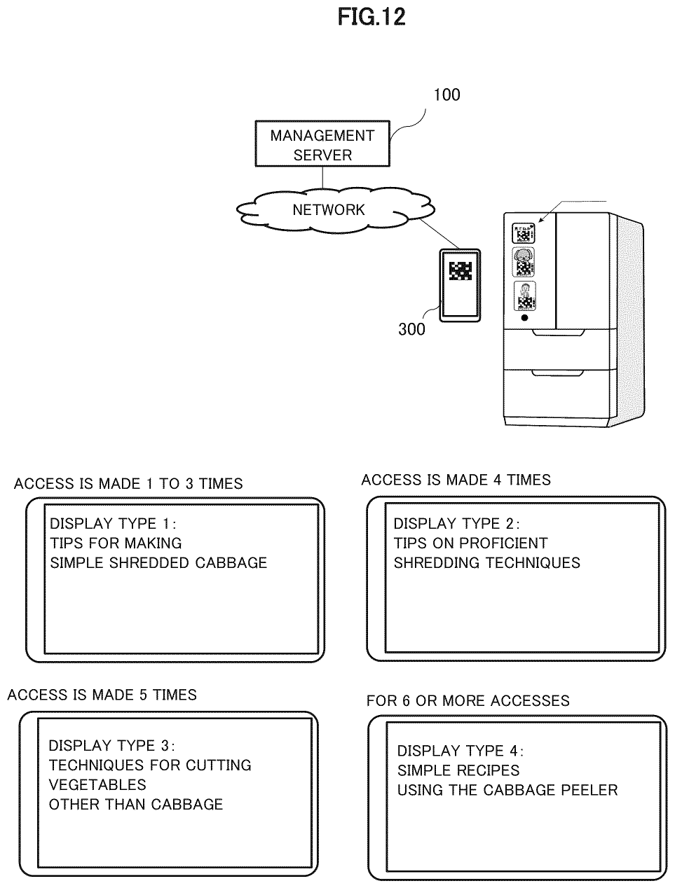

FIG. 12 is a diagram illustrating a configuration example of a content selection based on the number of accesses to the same URL. In this example, the content data provided by the management server 100 changes depending on the number of accesses to the same URL. Here, the number of accesses to the same URL refers to the count of times the same URL that is used for access, for each user terminal 300. Typically, the same URL access count refers to the number of times the same “Mite-ne QR Code” is scanned from the same user terminal 300 and accessed on the management server 100.

For example, if the “Mite-ne QR Code” is associated with the product “Cabbage Peeler,” a customer may peel off the “Mite-ne QR Code” from the cabbage peeler and reattach it to a household item (such as a refrigerator) to access it multiple times. Depending on the number of accesses, if access is made 1 to 3 times, the content data provided upon access from the user terminal 300 may include information of Display Type 1 (e.g., tips for making simple shredded cabbage). If access is made 4 times, the content data may include information of Display Type 2 (e.g., tips on proficient shredding techniques). If access is made 5 times, the content data may include information of Display Type 3 (e.g., techniques for cutting vegetables other than cabbage). For 6 or more accesses, the content data may include information of Display Type 4 (e.g., simple recipes using the cabbage peeler).

More specifically, the content data for Display Type 1, which provides tips for making simple shredded cabbage, primarily includes video content focused on basic usage (quick tips) lasting 1-2 minutes, enhanced with text, diagrams, arrows, sound effects, etc. The goal is to guide customers towards proper usage, help them recognize the convenience and ease of the product, and ideally encourage them to share its benefits with others (perhaps subtly prompting them to post on social media), thus contributing to information dissemination and expanded sales. At the end of the video, a standard phrase such as “New information coming soon. ‘See you again!’” is included. The video content explains specific operation steps for the product, including (1) choosing a heavy cabbage, (2) cutting it in half along the core, (3) holding the core with the thumb, (4) tilting the blade at a 45° angle, and (5) pulling it towards oneself with a long stroke, along with a brief summary and organized explanation.

For Display Type 2, which provides tips on proficient shredding techniques (know-how), the content primarily consists of video content aimed at guiding customers who have grasped the basic usage towards more advanced techniques, fostering greater enthusiasm and loyalty. Again, at the end of the video, a standard phrase such as “New information coming soon. ‘See you again!’” is included. The video content includes specific operation steps, such as (1) for thin slices, pull gently without applying pressure with the index finger, and for short slices, pull in a gouging motion; (2) for preventing leaf scatter, pull gently along the edges and remove excess leaves, along with a brief summary and organized explanation.

For Display Type 3, which covers techniques for cutting vegetables other than cabbage, the content is intended to encourage users who are satisfied with shredded cabbage to explore more versatile uses of the product, fostering greater enthusiasm and loyalty. Again, a standard phrase such as “New information coming soon. ‘See you again!’” is included at the end of the video. The video content provides specific operation steps, such as (1) for thinly slicing radishes, cut long, at an angle, or while rotating; (2) for slicing cucumbers, cut long, at an angle, or vertically; and (3) for slicing other vegetables like carrots and celery, along with a brief summary and organized explanation.

For Display Type 4, which provides simple recipes using the cabbage peeler, the content is intended to promote more advanced and effective use of the product for users already familiar with its usage, fostering greater enthusiasm and loyalty. Again, a standard phrase such as “New information coming soon. ‘See you again!’” is included at the end of the video. The video content includes (1) recipes for shredded cabbage, (2) recipes for thinly sliced radish, (3) recipes for vinegar dishes, etc., along with a brief summary and organized explanation.

This concludes the description of the product description support system 1. As shown in the embodiment, the product description support system 1 enables the easy provision of useful information about products, whether before or after purchase.

The content change unit 116 may vary the selection of content based on the user level of the customer. Specifically, the memory unit of the management server 100 stores information corresponding to content data and proficiency levels that indicate user familiarity. The content change unit 116 manages the user level of each customer for the product associated with the QR code (URL). As the number of times the URL is accessed from the user's terminal 300 increases, the content change unit 116 raises the user level. Conversely, if the customer requests the display of content data at a lower level than their current user level, the content change unit 116 adjusts the user level to match the level of the requested content. Then, the content change unit 116 selects content data based on the user level from among multiple content data options.

The present invention is not limited to the above-described embodiments. Various modifications are possible within the technical scope of the invention. For example, during the selection of content data in Step S103 of the content provision process, POS (Point of Sales) data owned by the store may be utilized to choose appropriate content data. For instance, sales volume or purchaser attributes by region, based on POS data, can be used to select the most suitable content data. The POS data may include sales information such as JAN code, sales date, sales region, store, sales volume, purchaser attributes, sales price, etc.

Furthermore, the content change unit 116 may use POS data to select content data in descending order of purchase rates within a specified time after viewing the content. This approach can provide content data with a higher promotional effect.

The content change unit 116 may also specify the current time, identify the product associated with the URL used for access and its sales region, and select content data based on the POS data, prioritizing content that results in higher purchase rates within a specified time after viewing. This approach can provide content data with a higher promotional effect.

### Second Embodiment

Alternatively, cookies may be stored on the user terminal 300, and content data may be selected using the cookie information. This is described as the second embodiment below. Since the second embodiment is essentially similar to the first embodiment, the differences will be explained.

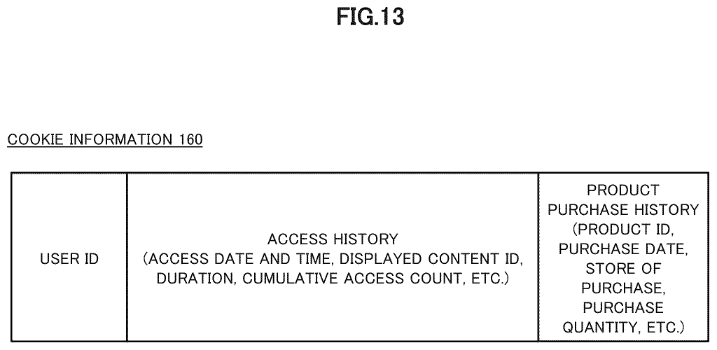

FIG. 13 is a diagram illustrating a configuration example of a cookie information in the second embodiment (use of cookies). The cookie information 160 includes a user ID, access history, and product purchase history. The access history includes the access date and time, displayed content ID, duration, cumulative access count, etc., for each URL accessed using the “Mite-ne QR Code.” The product purchase history includes the product ID, purchase date, store of purchase, purchase quantity, etc., for past purchases. The product purchase history will be further explained in the fourth embodiment.

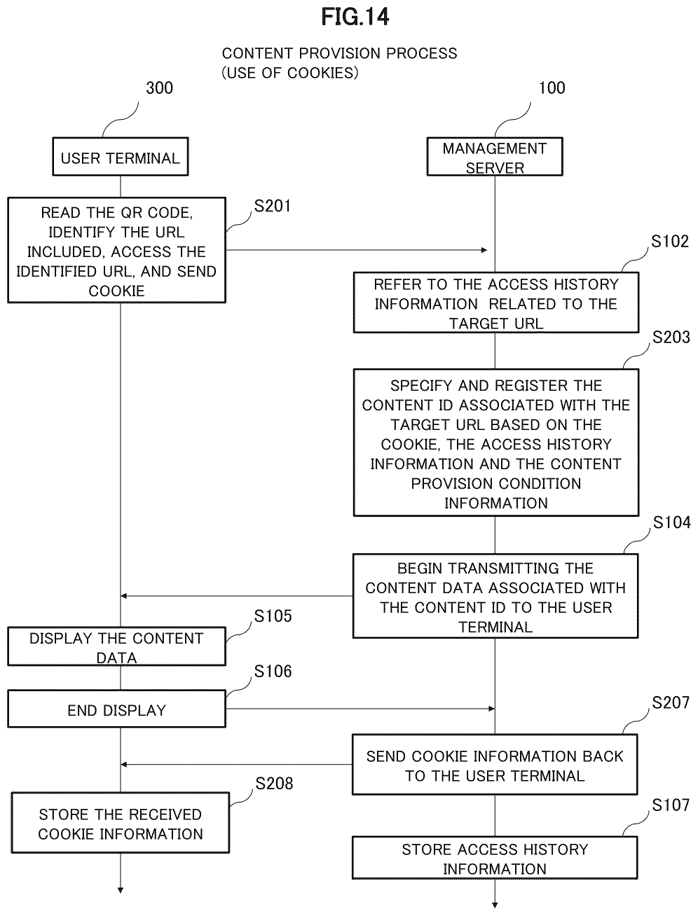

FIG. 14 is a diagram illustrating a configuration example of a flowchart of a content provision process in the second embodiment. First, the user terminal 300 reads the QR code labeled “Mite-ne QR Code” (QR code 500), identifies the URL included, and accesses the specified URL (Step S201). At this time, the cookie information 160 stored in the memory unit of the user terminal 300 is sent. The content change unit 116 then replaces Step S103 with processing that specifies the content ID associated with the target URL based on the cookie information 160, access history information 123, and content provision condition information 125, and registers this in the content association information 126 for the relevant session (Step S203).

Specifically, the content change unit 116 retrieves the same URL access count, which is the number of accesses to the URL used on the user terminal 300, from the cookie information 160, selects content data from among the multiple pieces of content data where the same URL access count satisfies the provision count, and registers it in the content association information 126 related to the session. Depending on the number of accesses to the same URL, more detailed content data may be selected. For example, during the first access, content data providing an overview of the purpose, use scenarios, and effects of the product may be displayed, while during subsequent accesses, content data with detailed functionality explanations may be displayed.

Alternatively, the content change unit 116 may retrieve the most recent access date and time or the initial access date and time to the URL used on the user terminal 300 from the cookie information 160 and select content data based on the elapsed time since the most recent access date and time or the initial access date and time. This approach allows the provision of suitable content data for users who access the product frequently or for users whose initial access occurred a specified period (e.g., one month) prior.

Once the display of the content data ends on the user terminal 300 (Step S106), the access history management unit 115 updates the access history, regenerates the cookie information 160, and sends it back to the user terminal 300 (Step S207). The user terminal 300 stores the received cookie information in a designated memory unit (Step S208).

If the streaming playback of the content data has finished, the content transmission unit 117 may continue playing other content data as long as viewing continues.

This concludes the processing of the content provision process in the second embodiment. According to the content provision process in the second embodiment, customers (users) can view content data tailored to the content provision conditions and based on the access history of their own user terminal 300, enabling them to easily obtain useful information on products before or after purchase.

### Third Embodiment

Alternatively, the user terminal 300 may store and execute application software compatible with the product description support system 1 (hereinafter referred to as the “app”), while the management server 100 retains user account information and access history for each customer, and upon access, selects content data using the account information. This is described below as the third embodiment. Note that the third embodiment is basically the same as the first embodiment, and therefore the differences will be mainly explained.

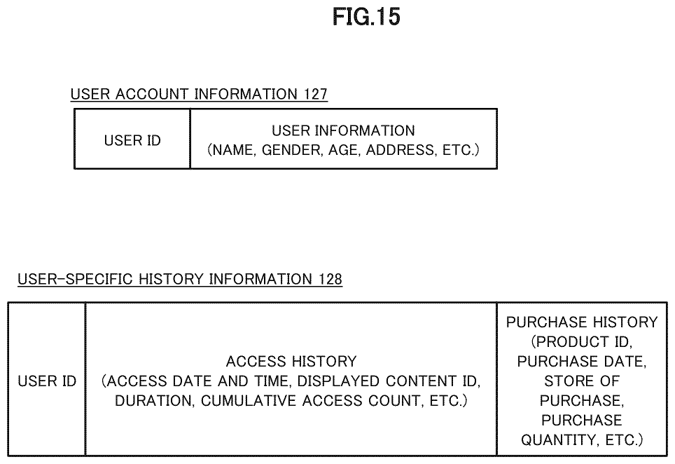

FIG. 15 is a diagram illustrating a configuration example of a user account information in the third embodiment (use of an application). The user account information 127 stores a user ID and user information in association. The user information includes items such as the user's (customer's) name, gender, age, and address. The name, gender, age, address, and other information of the user (customer) are entered by the user (customer) on the app on the user terminal 300. When information such as name, gender, age, and address is entered on the app on the user terminal 300, the user account management unit 118 assigns a user ID that distinguishes the user (customer) from others, and generates the user account information 127 and user-specific history information 128.

The user-specific history information 128 stores the user ID, access history, and purchase history in association. The access history includes information such as the access date and time, displayed content ID, stay time, cumulative access count, etc., for each URL accessed via the “Mite-ne QR Code.” The purchase history includes items such as the product ID, purchase date, purchase store, and purchase quantity of products purchased in the past. The purchase history will be further described in the fourth embodiment.

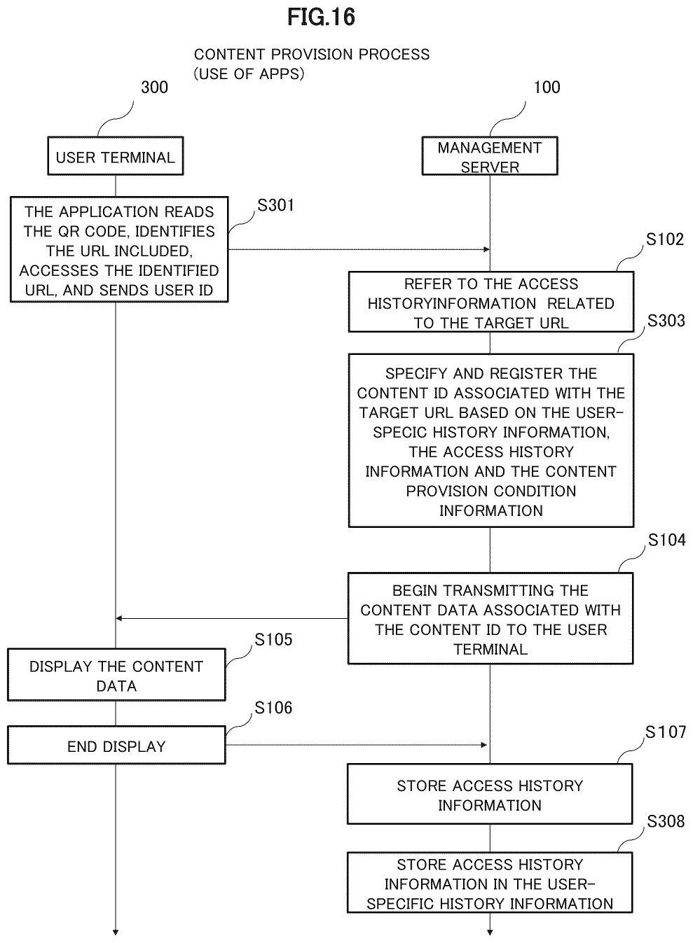

FIG. 16 is a diagram illustrating a configuration example of a flowchart of a content provision process in the third embodiment. First, the app on the user terminal 300 reads the QR code 500 of the “Mite-ne QR Code,” identifies the included URL, and accesses the specified URL (Step S301). At this time, the user ID set in the app is also transmitted.

Then, instead of Step S103, the content change unit 116 specifies the content ID associated with the target URL based on the user account information 127, user-specific history information 128, access history information 123, and content provision condition information 125, and registers this in the content association information 126 for the relevant session (Step S303).

Specifically, the content change unit 116 retrieves the count of accesses to the same URL on the user terminal 300, called the same URL access count, from the user-specific history information 128. From among multiple content data, the content change unit 116 selects the content data that satisfies the provision count based on the same URL access count, and registers it in the content association information 126 for the relevant session. At this time, content data that provides more detailed explanations may be selected according to the same URL access count. For example, on the first access, content data explaining an overview of purpose, usage scenarios, and effects may be provided, and on subsequent accesses, content data explaining detailed functions may be provided.

Alternatively, the content change unit 116 may retrieve the most recent access date or the initial access date to the URL used on the user terminal 300 from the user-specific history information 128, and select the content data based on the elapsed time since the most recent or initial access date. This enables the provision of appropriate content data for users who frequently access the product or for users whose initial access was a specified period (e.g., one month) ago.

Alternatively, the content change unit 116 may retrieve at least one of the gender, age range, or occupation from the user information in the user account information 127 and select content data that satisfies the target user attributes. This enables the provision of appropriate content data tailored to the user's attributes.

Alternatively, the content change unit 116 may retrieve the average viewing time of past accessed videos on the user terminal 300 and select video content data with a playback time that corresponds to the average viewing time. This allows the provision of appropriate content data based on the user's video viewing tendencies (such as how long they will watch a video to the end). That is, for users who tend to watch longer videos, content data including videos with longer playback times can be provided, and for users who tend not to watch longer videos, content data including videos with shorter playback times can be provided.

Then, when the streaming playback of the content data ends, the content transmission unit 117 may continue to play other content data as long as viewing continues.

Then, after the processing in Step S107, the access history management unit 115 stores access history information, including the content data ID displayed, in the user-specific history information 128 (Step S308).

The above describes the processing content of the content provision process in the third embodiment. According to the content provision process of the third embodiment, the customer (user) can view content data that is more likely to be desired by the customer, based on content provision conditions and on the access history of the customer's own user terminal 300. Therefore, it can be said that the customer can conveniently obtain more useful information about products before or after purchase.

### Fourth Embodiment

Next, the fourth embodiment will be explained. Note that the fourth embodiment is essentially the same as the first embodiment, so the differences will be mainly described.

The fourth embodiment is characterized by varying the content provided to the user depending on whether the product has been purchased. For this purpose, the management server 100 stores the purchase history of each product for each user in the user-specific history information 128.

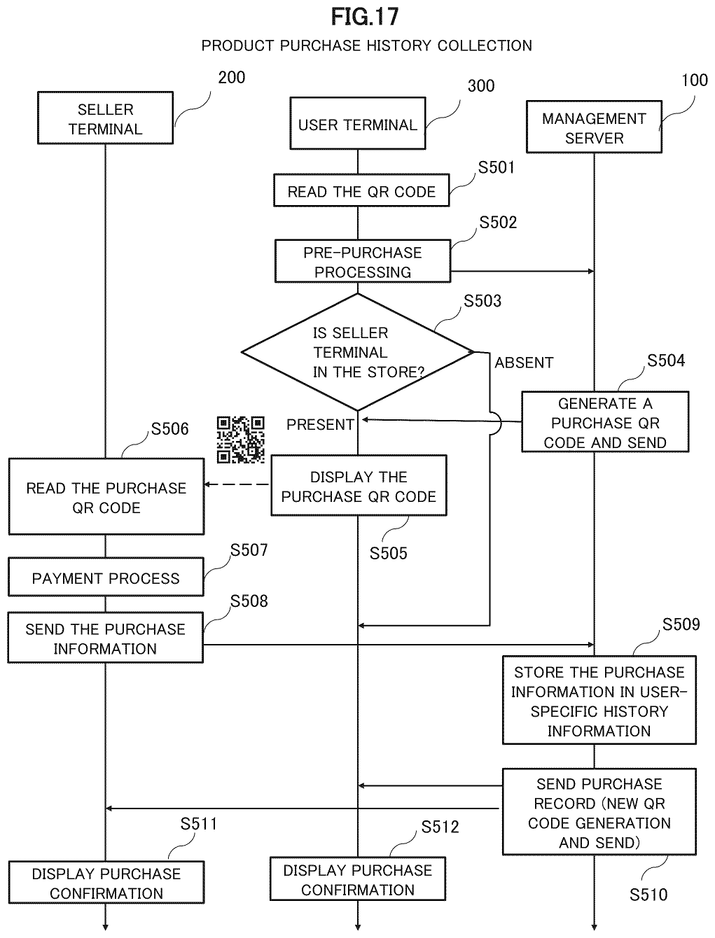

FIG. 17 is a diagram illustrating a configuration example of a flowchart of product purchase history collection in the fourth embodiment.

First, an example is shown where a dedicated app for performing purchase processing is installed on the user terminal 300.

The user terminal 300 reads the “Mite-ne QR Code” attached to the product to be purchased (Step S501). After that, when a purchase processing request is accepted from the user, the user terminal 300 accesses the URL included in the QR code and requests the management server to update the purchase history information (Step S502). At this time, the user terminal 300 also transmits the user ID to the management server 100.

Here, since it is assumed that there may not be a seller terminal 200 in the store, the user terminal 300 displays a screen that accepts input regarding the presence or absence of a seller terminal 200 in the store. If the user, who is a customer, enters “present” when a seller terminal 200 is in the store, or “absent” if it is not present. The user terminal 300 will, if “absent” is entered (Step S503), display purchase confirmation (Step S511) and then complete the process as a provisional purchase process.

On the other hand, when the user account management unit 118 of the management server 100 receives a request to update the purchase history information from the user terminal 300, the user account management unit 118 acquires the user's user ID and identifies the product ID based on the accessed URL. Then, the QR code issuance unit 113 of the management server 100 generates a purchase QR code containing the product ID, user ID, and accessed URL, and sends it to the user terminal 300 (Step S504). Here, the access URL is the URL used when the seller terminal 200 accesses the management server and includes the host name and domain name of the management server 100.

If “present” was entered for the seller terminal 200 (Step S503) and the user terminal 300 receives the purchase QR code from the management server 100, the user terminal 300 displays the received purchase QR code on its display (Step S505). The seller terminal 200 (cash register terminal in the store) reads the purchase QR code displayed on the user terminal 300 (Step S506). At this time, processes such as reward points for purchased products or discounts can be added. Once payment is completed, the seller terminal 200 accesses the URL included in the read QR code and sends the purchase information (including the user ID, product ID, purchase store, purchase date, and quantity) to the management server 100, indicating that the purchase has been completed (Step S507).

In response, the user account management unit 118 of the management server 100 acquires the user ID, product ID, purchase store, purchase date, and quantity from the purchase information and stores the product ID, purchase store, purchase date, and quantity in the purchase history of the corresponding user ID in the user-specific history information 128 (Step S509).

After updating the purchase history, the user account management unit 118 of the management server 100 sends information indicating that the purchase has been recorded to the seller terminal 200 and the user terminal 300 (Step S510). Upon receiving this, the seller terminal 200 displays information indicating that the purchase history has been updated and the purchase is complete (“Purchase Confirmation” display) (Step S511). Similarly, the user terminal 300 also displays information indicating that the purchase history has been updated and the purchase is complete (“Purchase Confirmation” display) (Step S512). For example, when purchasing the relevant product on an e-commerce site or similar platform over the Internet, the purchase QR code or URL can be sent to the EC site, which then receives the code or URL and transmits the purchase completion information to the management server 100, allowing the management server 100 to perform the purchase confirmation process (Steps S506-S510). By introducing the function of the seller terminal (cash register, etc.) 200 on the e-commerce site, the same processing can be performed even on the e-commerce site.

In the event of a return, the seller terminal 200 requests the management server 100 to cancel the purchase history for the relevant product, and in response, the user account management unit 118 of the management server 100 deletes the purchase history of the relevant product.

The process of collecting purchase history information has been described above.

Through the above processing, the content change unit 116 of the management server 100 can determine whether a specific user ID's user (customer) has purchased a particular product by referring to the purchase history information of that user ID. Therefore, when updating the content association information 126, the content change unit 116 can vary the selected content data depending on whether the product has been purchased. For example, if the product has not been purchased, content data specified by the provision condition “before purchase” that promotes the product for sale may be selected. Conversely, if the product has been purchased, content data specified by the provision condition “after purchase” that explains specific usage methods for the product may be selected.

In addition, when the purchase history is updated in Step S508, the QR code issuance unit 113 of the management server 100 may issue a new QR code indicating that the product has been purchased and send it to the user terminal 300 or the seller terminal 200. The information contained in the new QR code is the same as the information included in the previously described “Mite-ne QR Code,” but it may additionally include information indicating that the product has been purchased. Alternatively, when a new QR code is issued, the QR code issuance unit 113 may associate the purchase history information (user ID, product ID, purchase store, purchase date, purchase quantity) indicating that the product has been purchased with the QR code information 122.

When the seller terminal 200 receives the newly issued purchase QR code, it may, for example, print it on a card with an attached magnet and hand it to the customer. Naturally, the customer can also print it themselves. The customer can store it on their refrigerator or other location, and whenever they wish to view the content, they can simply scan the QR code to easily access useful content.

### Modified Example of the Fourth Embodiment

In the fourth embodiment described above, the user terminal 300 sent a purchase processing request to the management server 100 using the installed dedicated app. However, it is not limited to this, and purchase processing may be performed using cookie information on a user terminal 300 that does not have the dedicated app installed.

Specifically, the user terminal 300 reads the “Mite-ne QR Code” attached to the product to be purchased (Step S501), identifies the URL included in the QR code, and accesses the management server 100 using the identified URL. At this time, the user terminal 300 sends cookie information, including the user ID, to the management server 100.

The management server 100 sends the content data to the user terminal 300 by performing the processing of Steps S102, S203, and S104 shown in FIG. 14. The content data includes content that allows a “pre-purchase processing button” to be displayed on the web page to accept a purchase processing request.

When the user terminal 300 accepts a purchase processing request from the user who has decided to purchase the product, it sends the request to the management server 100.

Here, since it is assumed that there may not be a seller terminal 200 in the store, the management server 100 displays a screen on the browser of the user terminal 300 or other device to accept input regarding the presence or absence of a seller terminal 200 in the store. The user, who is a customer, enters “present” if there is a seller terminal 200 in the store, or “absent” if it is not present. The subsequent processing is the same as Steps S504 to S512 described above. However, since the dedicated app is not installed on the user terminal 300, the management server 100 sends the information for display to the user terminal 300 and displays it. The management server 100 sends cookie information containing the purchase history to the user terminal 300, and the user terminal 300 stores the received cookie information.

Through this processing, even without installing the dedicated app, the purchase history information for the product is stored in the management server 100, allowing it to determine whether a specific product for a particular user has been purchased.

Additionally, the content change unit 116 may change the content data associated with the URL depending on whether the customer who accessed it has introduced the product to another person. Specifically, the management server 100 includes a privilege-granting unit that issues an introduction image code (referred to as a QR code or other codes that can be displayed on a flat surface, also called an introduction code) associated with at least the first customer's user ID, the product ID of the purchased product, the access URL, and certain privileges applicable when the introduced customer purchases the product. This privilege-granting unit may be the aforementioned QR code issuance unit 113. When the privilege-granting unit receives an access from a second customer (introduced person) distinct from the first customer (introducer) using the access URL included in the introduction image code, it stores specified flag information in the memory unit 120 as evidence that the first customer (introducer) introduced the product to someone. The content change unit 116 can change the content ID associated with the target URL during content provision based on the presence or absence of this specified flag information. For example, for those who have become introducers of the purchased product, content that includes a catchy phrase that succinctly expresses the product's functionality can be selected, enabling the user to highlight the product's appeal to others. This supports the customer in actively introducing the product.

Furthermore, the content change unit 116 may change the content data associated with the URL depending on whether the customer who accessed it has experience introducing other products different from the relevant product (for example, whether they have introduced other products they purchased in the past few months). Specifically, the management server 100 includes a privilege-granting unit that issues an introduction image code (referred to as a QR code or other codes that can be displayed on a flat surface, also called an introduction code) associated with at least the first customer's user ID, the product ID of the purchased product, the access URL, and certain privileges applicable when the introduced customer purchases the product. This privilege-granting unit may be the aforementioned QR code issuance unit 113. When the privilege-granting unit receives an access from a second customer (introduced person) distinct from the first customer (introducer) using the access URL included in the introduction image code, it stores the specified flag information along with a timestamp in the memory unit 120 as evidence that the first customer (introducer) introduced the product to someone. The content change unit 116 determines whether the customer has introduced another product based on the timestamp and the presence or absence of the specified flag information. For customers who have experience as introducers of other products, content can be selected that clearly highlights key points or selling points of the introduction, thereby supporting active introductions.

Moreover, the content change unit 116 may change the content data associated with the URL depending on whether the access was made using an access identifier included in the introduction image code. Specifically, the management server 100 includes a privilege-granting unit that issues an introduction image code (referred to as a QR code or other codes that can be displayed on a flat surface, also called an introduction code) associated with at least the first customer's user ID, the product ID of the purchased product, the access URL, and certain privileges applicable when the introduced customer purchases the product. This privilege-granting unit may be the aforementioned QR code issuance unit 113. When the privilege-granting unit receives an access from a second customer (introduced person) distinct from the first customer (introducer) using the access URL included in the introduction image code, it determines that the access was made using the access identifier included in the introduction image code. This allows the content change unit 116 to change the content data associated with the URL. Since the introduced person may have already heard an overview from the introducer, content explaining the functionality and usage in detail can be selected, supporting the customer in making a purchase decision.

Note that the information shown as the access URL in the above embodiments is merely an example, and it may be any identifier (access identifier) in a format other than a URL format. Additionally, the URLs shown above may be handled more conveniently by using shortened URLS.

Additionally, the content change unit 116 may adopt one or more methods, as described in the above embodiments, to select content according to a predetermined rule, thereby changing the content. Specifically, the methods are as follows:
Method 1) Selecting content data that meets a predetermined provision count from among the multiple pieces of content data;
Method 2) Obtaining the access count N, representing the number of accesses to the access identifier used by the customer's user terminal, and selecting content data that meets the provision count from among the multiple pieces of content data;
Method 3) Selecting content data that provides more detailed information based on the access count N;
Method 4) Managing the customer's user level, where the user level increases with more frequent accesses, and if content data with a lower level than the current user level is requested, the user level is lowered to the level of the requested content data. Content data is then selected according to the user level;
Method 5) Obtaining the most recent access date and time for the access identifier used on the customer's user terminal and selecting content data based on the elapsed time since the access date and time;
Method 6) Determining the average viewing time or percentage of viewing time for videos related to past accesses at the customer's user terminal, and selecting video content data with playback time corresponding to the average viewing time or percentage of viewing time;
Method 7) Selecting content data in descending order of purchase rates for the product associated with the content data within a specified time after viewing;
Method 8) The memory unit in the management server contains information associated with the sales region for each product and information corresponding to the region and time period for each content data. The content change unit specifies the current time, identifies the product associated with the URL used for access, and selects, from among the multiple pieces of content data, content data for which the sales region of the identified product corresponds to the provision region, and the current time corresponds to the time period, prioritizing content with higher purchase rates within a specified time after viewing;
Method 9) Selecting different content data based on whether or not the product associated with the URL used for access has been purchased;
Method 10) Obtaining at least one of gender, age group, and occupation from the attribute information of the customer who accessed said customer's user terminal, and selecting content data from among the multiple pieces of content data using the information in the memory section, wherein the attribute information of the customer satisfies the target person attributes to be provided.

It should be noted that the predetermined rule may involve randomly selecting any “method” from among Methods 1 to 10. Alternatively, a generative AI may be used to select any of the methods.

Additionally, the functions of the management server 100 may be implemented by a system comprising one or more computers.

Furthermore, the technical elements of the above-described embodiments may be applied individually or may be divided into multiple parts, such as program components and hardware components, and applied accordingly.

The present invention has been described above with a focus on the embodiments.

### DESCRIPTION OF SYMBOLS

1: Product Description Support System, 100: Management Server, 110: Processing Unit, 111: Product Information Registration Unit, 112: Content Registration Unit, 113: QR Code Issuance Unit, 114: Access Reception Unit, 115: Access History Management Unit, 116: Content Change Unit, 117: Content Transmission Unit, 118: User Account Management Unit, 120: Memory Unit, 121: Product Information, 122: QR Code Information, 123: Access History Information, 124: Content Information, 125: Content Provision Condition Information, 126: Content Association Information, 127: User Account Information, 128: User-Specific History Information, 150: Communication Unit.

What is claimed is:

1. A product description support system executed by a computer system including a management server, comprising:
an access reception unit that accepts access performed using an access identifier (e.g., URL) included in a code pre-associated with a product when read by the customer's user terminal;
a content change unit that selects content data corresponding to the access identifier from among multiple pieces of pre-stored content data according to predetermined provision conditions, thus changing the content data associated with the access identifier;
a content transmission unit that sends the changed content data to the customer's terminal for display, allowing it to be viewed on the user terminal; and
an access history management unit that records the provision history of each content data,
wherein the content change unit selects content data by adopting one of the following methods:
Method 1) selecting content data from among the multiple pieces of content data that satisfies a predetermined provision count;
Method 2) obtaining an access count N, which is the number of accesses to the access identifier used by the customer's user terminal, and selecting content data from among the multiple pieces of content data where the access count N satisfies the provision count;
Method 3) selecting more detailed content data from among the multiple pieces of content data according to the access count N;
Method 4) managing the user level of the customer, increasing the user level as the number of accesses to the access identifier used by the customer's user terminal increases, and, if the customer requests to view content data at a level lower than the current user level, adjusting the user level to the requested content level, and selecting content data from among the multiple pieces of content data according to the user level;
Method 5) obtaining the most recent access date and time of the access identifier used by the customer's user terminal and selecting content data based on the elapsed time since that access date and time;
Method 6) identifying the average viewing time or the ratio of viewing time for videos related to past accesses on the customer's user terminal and selecting video content data with a playback time corresponding to the average viewing time or the ratio of viewing time from among the multiple pieces of content data;
Method 7) selecting content data from among the multiple pieces of content data based on the purchase rate of the product within a specified time after viewing, in descending order of purchase rate;
Method 8) storing, in the memory unit of the management server, information associating each product with a sales region and information associating each piece of content data with a provision region and time period, identifying the product associated with the URL used in the access, specifying the sales region of the identified product, and selecting content data from among the multiple pieces of content data where the sales region of the identified product corresponds to the provision region and the current time corresponds to the time period;
Method 9) selecting different content data depending on whether the product associated with the URL used in the access has already been purchased; and
Method 10) obtaining at least one of gender, age group, or occupation from the attribute information of the customer who performed the access on the user terminal, and selecting content data from among the multiple pieces of content data that satisfies the target attributes using the information in the memory unit.

2. The product description support system according to claim 1, wherein
the content change unit instructs a generative AI to select any of methods 1 to 10, and adopts the method selected by the generative AI.

3. A product description support system executed by a computer system including a management server, comprising:
an access reception unit configured to receive access performed using a QR code pre-associated with a product by a user terminal of a customer, the access using a URL included in the QR code;
a content change unit configured to change content data associated with the URL by selecting from multiple pieces of pre-stored content data according to predetermined provision conditions; and
a content transmission unit configured to transmit the changed content data to the customer's terminal and display it on the customer's user terminal for viewing,
wherein the memory unit of the management server stores information associating each piece of content data with a provision count for providing the content data to the same terminal, and the content change unit obtains the same URL access count, which is the number of accesses to the URL used in the access by the user terminal of the customer, and selects content data from among the multiple pieces of content data where the same URL access count satisfies the provision count.

4. The product description support system according to claim 3, wherein
the memory unit of the management server stores information associating each piece of content data with a provision count for providing the content data to the same terminal, and the content data includes more detailed descriptions of the product as the provision count increases; and
the content change unit obtains the same URL access count, which is the number of accesses to the URL used in the access by the user terminal of the customer, and selects more detailed content data from among the multiple pieces of content data according to the same URL access count.

5. A product description support system executed by a computer system including a management server, comprising:
an access reception unit configured to receive access performed using a QR code pre-associated with a product by a user terminal of a customer, the access using a URL included in the QR code;
a content change unit configured to change content data associated with the URL by selecting from multiple pieces of pre-stored content data according to predetermined provision conditions; and
a content transmission unit configured to transmit the changed content data to the customer's terminal and display it on the customer's user terminal for viewing,
wherein the memory unit of the management server stores information associating each piece of content data with a level indicating the degree of proficiency, and the content change unit manages the user level of the customer, increases the user level as the access count to the URL used in the access by the user terminal of the customer increases, and, if the customer requests to view content data at a level lower than the current user level, adjusts the user level to match the requested content level and selects content data from among the multiple pieces of content data according to the user level.
